(19) United States
(12) Patent Application Publication
(10) Pub. No.: US 2015/0217295 A1
(43) Pub. Date: Aug. 6, 2015

(54) ROLL FOR A ROLLER GRINDER, AND ROLLER GRINDER COMPRISING SUCH ROLL

(71) Applicant: METSO BRASIL INDÚSTRIA E COMÉRCIO LTDA, Sorocoba, SP (BR)

(72) Inventors: Andrzej Niklewski, Alto de Pinheiros (BR); Paulo Barscevicius, Sorocaba (BR)

(73) Assignee: METSO BRASIL INDÚSTRIA E COMÉRCIO LTDA, Sorocaba, SP (BR)

(21) Appl. No.: 14/423,827

(22) PCT Filed: Aug. 26, 2013
(86) PCT No.: PCT/IB2013/056886

§ 371 Date: Feb. 25, 2015

(30) Foreign Application Priority Data
Aug. 29, 2012 (EP) 1218107.8

(51) Int. Cl. B02C 4/30

(52) U.S. Cl. CPC B02C 4/30

(57) ABSTRACT

The present disclosure relates to a roll for a roller grinder. The roll includes a shaft having a support structure; a plurality of grinding shell segments circumferentially arranged around the shaft to form a tubular grinding shell supported by the support structure; and a wedging device for each grinding shell segment. Each wedging device is arranged in a channel extending axially along the shall and defined by the associated grinding shell segment and the support structure. Each wedging device is arranged to releasably secure the grinding shell segment to the support structure. The present disclosure also relates to a high pressure grinder including the above roll.

### TECHNICAL FIELD OF THE INVENTION

The present invention relates to a roll for a roller grinder, the roll comprising a shaft and a grinding shell in the form of a generally tubular sleeve. The invention further relates to a high pressure roller grinder.

### BACKGROUND ART

High pressure roller grinders for grinding rock and the like are for obvious reasons subjected to a high level of wear from the processed material. Each roll of a roller grinder therefore commonly utilizes an outer cylindrical grinder shell made of a wear resistant material covering the rolls. The grinder shell eventually has to be replaced when worn down by the processed material, causing an interruption of the operation of the equipment.

The grinding or crushing shell has to be tightly mounted around a hub portion of the shaft, with a high friction between the parts to avoid loosening of the shell during operation of the grinder. The hub portion of the shaft may have a cylindrical shape or may be slightly conical to enable easy mounting and dismounting of the grinder shell. The conicity is preferably minimal, to prevent the grinding shell from being undesirably released during operation of the grinder.

In a known constructive solution, the outer grinding shell is designed to be mounted around the hub portion of the shaft by means of thermal expansion-contraction. The outer grinding shell is heated to present a thermal expansion sufficient to allow it to axially slide around the shaft, until reaching the mounting position, in which its cooling and shrinkage produce its retention, by high interference, around the hub portion of the shaft, the hub portion being generally cylindrical.

This known mounting solution presents some inconveniences. The outer grinding shell can crack upon cooling, particularly when it is made of hard high carbon steel. The mounting solution by thermal expansion-contraction of the outer grinding shell also presents inconveniences when dismounting the grinding shell from the hub portion of the shaft. The dismounting is extremely difficult due to the high level of frictional interference between the two parts. This difficulty is so great and time consuming that it is frequently preferred to replace the whole shaft-grinding shell assembly, undesirably increasing the costs of replacing the already worn out grinding shells. This problem is particularly cost inducing when the frequency of these replacements is high due to a high level of wear of the outer shell. It is also frequent, in such cases, that the shaft is damaged during the dismounting procedure, further increasing the replacement costs of the grinding shell. In many cases, the bearings, which are usually an expensive part, are integrated in the shaft assembly, further increasing the cost of the replacement when not being able to dismount the outer shell.

In general, use of a one-piece grinding shell leads to difficulties when replacing a worn roll, since the shaft, the grinding shell, and the bearings have to be removed from the machine, thereby necessitating disconnection of the drive system, the feed chute, etc. Therefore, grinding shells made up of several segments have been suggested.

CN102211111 discloses a composite roll comprising a shaft having a support structure with an N-side cross section, and a segmented grinding shell consisting of N inserts, wherein the N inserts are arranged on N mounting surfaces of the core roll in a one-to-one correspondence mode. The bottom surface of each insert is contacted with a corresponding mounting surface. Two ends of each insert are provided with insert legs. Two ends of the mounting surface corresponding to each insert are provided with insert grooves matched with the insert legs. The insert legs are inserted into the insert grooves and are connected with the core roll through bolts. In addition, the bottom surfaces of the inserts and the mounting surfaces are provided with convex parts and groove parts which correspond one to one so as to further improve the torsional behavior of the roll. However, due to the long distance between the fixation points, material will enter between the grinding shell and the support structure and start wearing down the interface surface between the grinding shell and the support structure during operation of the roll. This wear will limit the lifetime of the grinding shell segments as well as the lifetime of the support structure. Moreover, high and uneven forces will move the segments of the grinding shell in relation to the support structure also limiting the lifetime of the grinding shell segments and the support structure.

### SUMMARY OF THE INVENTION

It is an object of the present invention to solve, fully or partially, the above problems and to provide an improved roll for a roller grinder having an outer grinding shell that is easy to mount and dismount, so as to reduce costs when exchanging worn down grinder shells, while still providing a grinding shell that does not loosen during operation of the grinder.

In particular, according to a first aspect of the present invention a roll for a roller grinder is provided. The roll comprises a shaft having a support structure; a plurality of grinding shell segments circumferentially arranged around said shaft to form a tubular grinding shell supported by said support structure; a wedging arrangement for each grinding shell segment, wherein each wedging arrangement comprises at least one wedging device arranged in a channel extending axially along said shaft and defined by the associated grinding shell segment and the support structure, wherein each wedging arrangement is arranged to releasably secure said grinding shell segment to said support structure.

According to the present invention the grinding shell of the roll for a roller grinder is segmented in a plurality of grinding shell segments, which results in a grinding shell that is divided into smaller pieces. A benefit from this is that the grinding shell may be easier to manufacture than a one piece grinding shell. Moreover, such a grinding shell is easier to transport and handle. It is easier to transport and handle the big grinding shell in pieces than transporting and handling the one piece grinding shell. Furthermore, since it is easier to manufacture and transport the grinding shell according to this invention a bigger number of manufactories will be available. Moreover, when mounting the grinding shell to the shaft a smaller lifting device is needed as compared with mounting the one piece grinding shell. By securing the grinding shell segment to the shaft by a wedging arrangement it is easy to assemble and disassemble the grinding shell. Moreover, by securing the grinding shell segment to the shaft by the use of the wedging arrangement a preload between the grinding shell segment and the support structure of the shaft may be applied. By arranging the wedging device in a channel extending axially along said shaft the wedging force applied by the wedging device may be distributed over the whole contact surface between the supporting structure and the grinding shell segment. Especially, a preload between the grinding shell segment and the support structure of the shaft may be applied which is sufficient to support the segment, this assuring a strong permanent contact between grinding shell segment and the support structure of the shaft. The strong permanent contact between grinding shell segment and the support structure of the shaft minimizes the wear between the grinding shell segment and the support structure of the shaft. Thus, the lifetime of the grinding shell segments and the support structure is extended. By releasably securing the grinding shell segment to the support structure of the shaft by the wedging device it is easy to dismount the grinding shell segment from the support structure of the shaft. Thus, it is easy to exchange a worn down grinding shell by usage of the roll in a roller grinder.

Each wedging arrangement may be arranged to apply a wedging force pressing a segment contact surface of the grinding shell segment and a corresponding support structure contact surface of the support structure against each other.

Each channel may have an axial extension along said shaft being essentially as long as the associated grinding shell segment. Each wedging device may further be arranged to apply a wedging force along essentially the whole axial extension of the associated grinding shell segment. This ensures that the wedging force applied by the wedging device is distributed over the whole contact surface between the supporting structure and the grinding shell segment, ensuring a strong permanent contact between the grinding shell segment and the support structure minimizing the wear between the grinding shell segment and the support structure of the shaft.

Said wedging device may comprise at least one wedge and a tensioner, wherein said tensioner is arranged to apply a force pushing said at least one wedge in an axially extending wedge locking direction.

Said wedging device may comprise two wedges having opposed wedge locking directions, wherein said tensioner is arranged to apply a force pushing each of said two wedges in its wedge locking direction, respectively. By using two wedges having opposed wedge locking directions an evenly distributed wedging force between the grinding shell segment and the support of the shaft is provided.

Said at least one wedge may be segmented into a plurality of wedge portions. Since the distance between edge of grinding shell and the roller bearings holding the shaft is limited and because said at least one wedge is segmented into a plurality of parts, especially split in a direction being perpendicular to the axial extension of the shaft it will be possible to dismount said at least one wedge without having to disassemble the roller bearings.

Said tensioner may comprise a rod and at least one tension nut. By using a rod and a tension nut an evenly distributed tension force is applied to the wedging device.

Each grinding shell segment may comprise a groove which together with a groove in said support structure of said shaft defines the channel associated thereto.

Said groove of each grinding shell segment and said groove in said support structure may both be T-shaped in a cross section being perpendicular to the axial extension of the roll. It should be noted, that as used herein, “T-shaped” is not restricted to a strict T-shape. More particularly, the angles between the members of the T need not be perpendicular. For instance, a sloped surface may connect the top member of the T with the foot member.

Said channel extending axially along said shaft and defined by the associated grinding shell segment and the support structure may be provided with a waist arranged in an interface surface between said grinding shell segment and said support structure. By providing the channel with a waist arranged in an interface surface between said grinding shell segment and said support structure it is possible to insert a wedging device having wedges being provided with a corresponding waist. Such an arrangement ensures that the wedges of the wedging device pull the grinding shell segment against the support structure of the shaft.

Said at least one wedge may be H-shaped in a cross section being perpendicular to the axial extension of the roll.

According to another aspect of the present invention a high pressure roller grinder comprising a roll according to the above is provided.

### BRIEF DESCRIPTION OF THE DRAWINGS

These and other aspects of the present invention will now be described in more detail, with reference to appended drawings showing embodiments of the invention. The figures should not be considered limiting the invention to the specific embodiment; instead they are used for explaining and understanding the invention.

FIG. 1a shows one of the rolls in a high pressure roller grinder (not fully shown) according to prior art.

FIG. 1b shows the grinding shell as shown in FIG. 1a when not being mounted on the shaft.

FIG. 2 shows a part of a roll in a preferred embodiment of a roller grinder (not fully shown) according to the present invention.

FIG. 3 shows a segment of the grinding shell of the embodiment according to FIG. 2 not being mounted on the roll.

FIG. 4 shows the shaft and its support structure of the roll according to FIG. 1 before any segments of the grinding shell have been mounted thereon.

FIG. 5 shows sloped internal surfaces of support structure grooves being formed by inserts.

FIG. 6 shows an insert according to FIG. 5.

FIG. 7 shows a wedging device according to the embodiment of FIG. 1 having wedges being split in two wedge portions.

FIG. 8 shows an alternative embodiment of the present invention.

FIG. 9 illustrates how the contact surfaces of the support structure and the grinding shell segment are oriented according to the embodiment of FIG. 8.

### DETAILED DESCRIPTION OF PREFERRED EMBODIMENTS OF THE INVENTION

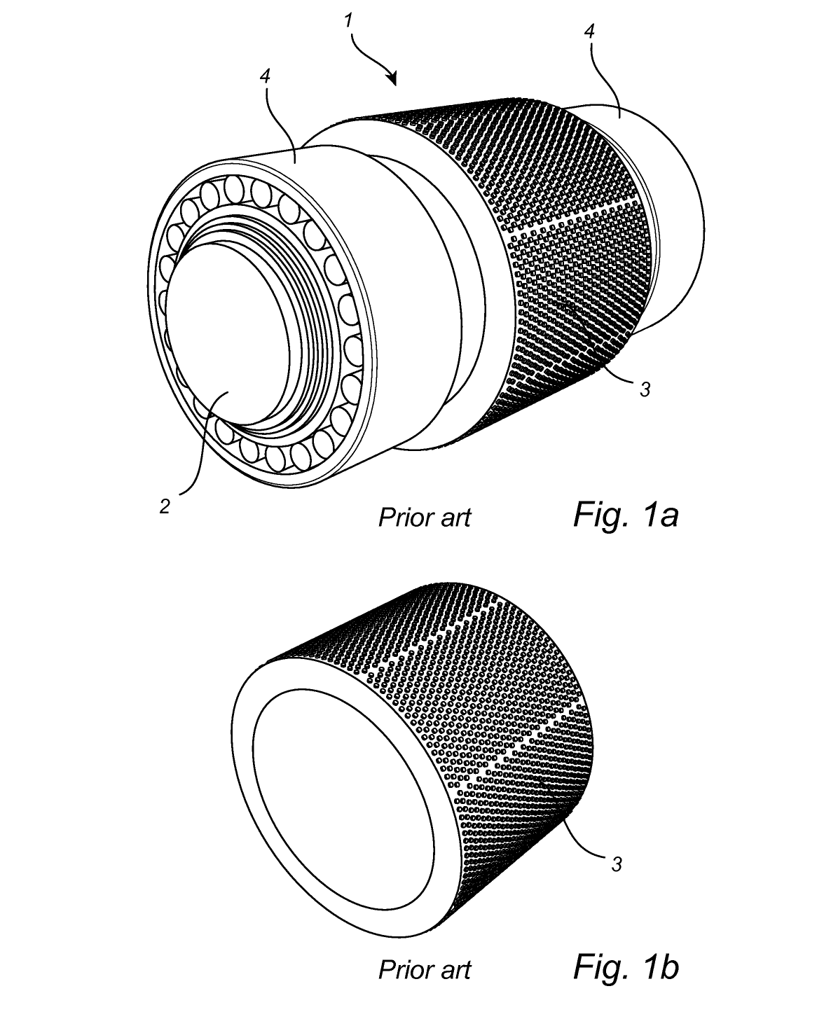

FIG. 1a shows one of the rolls 1 in a high pressure roller grinder (not fully shown) according to prior art. The roll 1 comprises a shaft 2 and a grinding shell 3 in the form of a generally tubular sleeve. The grinding shell 3 surrounds a hub of the shaft 2. The shaft 2 is held in the roller grinder by two bearings 4. For high pressure roller grinders it is not unusual for the roll to weigh in the order of 100 tons, wherein the grinding shell itself weighs in the order of 10 tons.

FIG. 1b shows the grinding shell 3 as shown in FIG. 1a when not being mounted on the shaft.

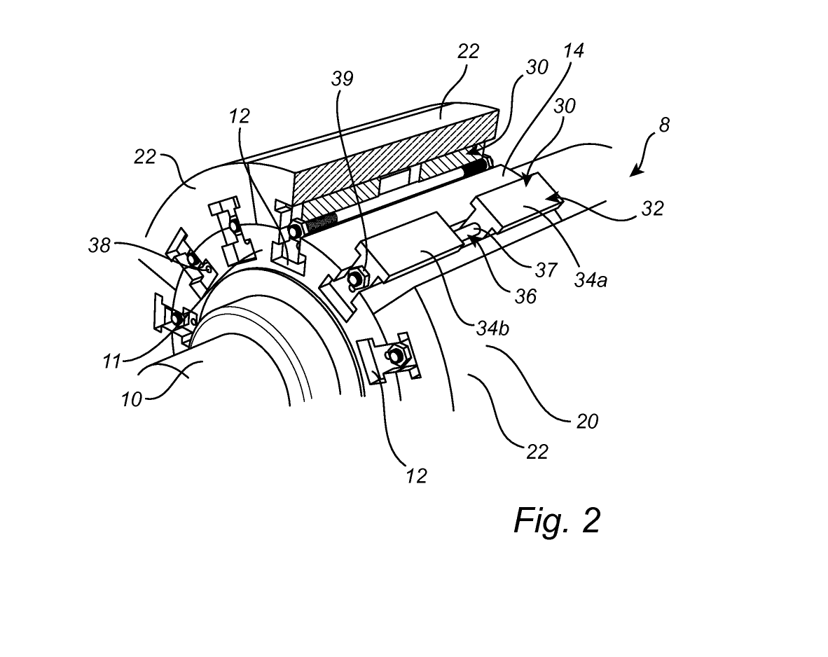

With reference to FIG. 2-7 a preferred embodiment of a roller grinder (not fully shown) according to the present invention will be described.

FIG. 2 shows a part of a roll 8 in a preferred embodiment of a roller grinder (not fully shown) according to the present invention. The roll 8 comprises a shaft 10, the shaft 10 being held in the roller grinder by two bearings (not shown). Moreover, the roll 8 comprises a grinding shell 20 in the form of a generally tubular sleeve surrounding a support structure 11 of the shaft 10. The grinding shell 20 is divided into a plurality of segments 22. In FIG. 2 a part of one of the segments of the generally tubular sleeve is removed in order to more clearly see the function of the present invention.

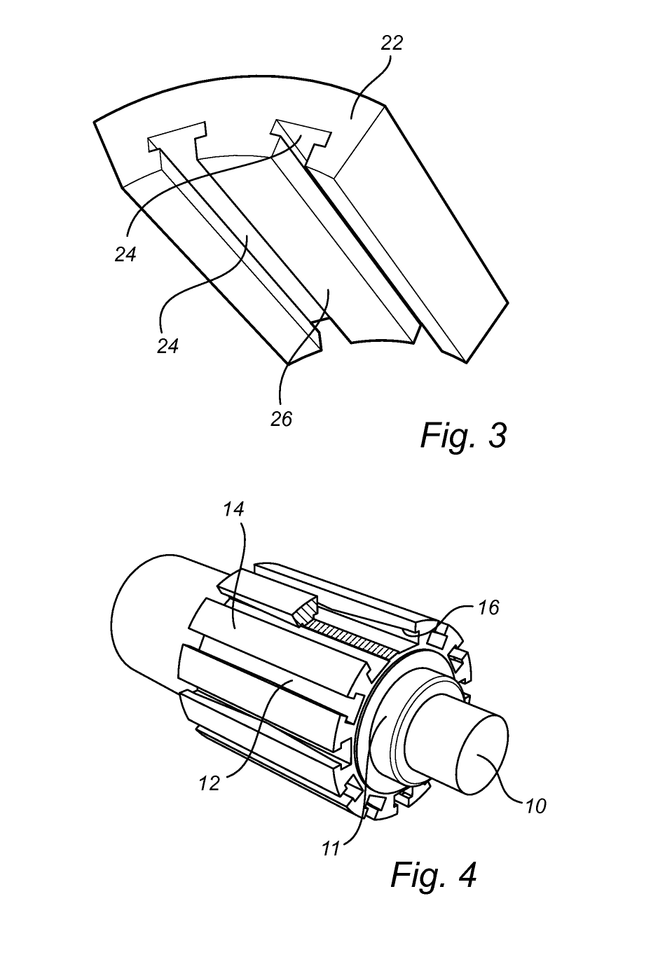

FIG. 3 shows a segment 22 of the grinding shell not being mounted on the roll. Each segment 22 is provided with a shell groove 24. The shell groove 24 is T-shaped in a cross section being perpendicular to the axial extension of the roll 8. The shaft 10 is provided with a plurality of support structure grooves 12. The support structure grooves 12 are T-shaped in a cross section being perpendicular to the axial extension of the roll 8. The number of support structure grooves 12 corresponds to the number of shell grooves 24 of all of the segments 22 of the grinding shell 20. The T-shaped shell groove 24 of one of the segments 22 of the grinding shell 20 and one of the T-shaped support structure grooves 12 is forming a channel, the channel being H-shaped. The channel is extending axially along the shaft 10. The channel is defined by the associated grinding shell segment 22 and the support structure 11.

The roll 8 further comprises a plurality of wedging arrangements 30. Each wedging arrangement 30 is arranged to releasably secure one of the grinding shell segments 22 to the support structure 11. This is made by applying a wedging force pressing a segment contact surface 26 of the grinding shell segment 22 and a corresponding support structure contact surface 14 of the support structure 11 against each other.

Each wedging arrangement 30 comprises at least one wedging device 32. According to the embodiment shown in FIG. 2 the wedging arrangement 30 comprises two wedging devices 32. Each wedging device 32 comprises two wedges 34a, 34b and a tensioner 36. The wedges 34a, 34b are H-shaped in a cross section being perpendicular to the axial extension of the roll 8. A first T-shaped section of each wedge 34a, 34b is fitting into one of the support structure grooves 12 and a second T-shaped section of each wedge 34a, 34b is fitting into the corresponding shell groove 24. The wedging device 32 is arranged to apply a holding pressure between each segment 22 of the grinding shell 20 and the support structure 11 of the shaft 10. More precisely, the wedging device 32 according to this embodiment of the invention is arranged to apply the holding pressure by pressing each segment 22 of the grinding shell 20 against the support structure 11 of the shaft 10.

FIG. 4 shows the shaft 10 and the support structure 11 of the roll before any segments 22 of the grinding shell 20 have been mounted thereon. The two internal surfaces 16 of the support structure grooves 12 facing the grinding shell 20 are sloped for allowing the creation of a wedging force creating the holding pressure between each segment 22 of the grinding shell 20 and the support structure of the shaft 10 when the wedging device 32 is introduced into the channel. The taper of the slope of said internal surfaces 16 is according to the presently used embodiment between 1° and 10°, preferably between 3° and 7° and more preferably 5°.

As is readily understood by the person skilled in the art, instead of having sloped internal surfaces of the support structure grooves 12 the two internal surfaces of the shell groove 24 facing the support structure 11 of the shaft 10 may be sloped for allowing the creation of the wedging force creating the holding pressure between each segment 22 of the grinding shell 20 and the support structure 11 of the shaft 10 when the wedging device 32 is introduced into the channel. Alternatively, both the support structure grooves 12 as well as the shell grooves 24 may comprise sloped internal surfaces for allowing the creation of the wedging force creating the holding pressure between each segment 22 of the grinding shell 20 and the support structure 11 of the shaft 10 when the wedging device 32 is introduced into the channel.

The wedges 34a, 34b of the wedging device 32 comprises faces (sloped or not) combining with the internal surfaces of the support structure grooves 12 and the shell grooves 24.

The wedges 34a, 34b of the wedging device 32 comprise a through hole. The through hole is arranged to receive a tension rod 37 of the tensioner 36

The wedges 34a, 34b of the wedging device 32 comprise a threaded hole 38. The threaded hole 38 is used together with a disassembling bolt (not shown) in order to be able to remove the wedges 34a, 34b when replacing a segment 22 of the grinding shell 20.

In order to achieve the wedging force creating the holding pressure between each segment 22 of the grinding shell 20 and the support structure 11 of the shaft 10 a first 34a one, of the two H-shaped wedges, is introduced into one of the H-shaped channels being formed by the T-shaped shell groove of one of the segments 22 of the grinding shell 20 and one of the T-shaped shaft grooves 12 of the support structure 11 at a first side of the roll 8 and a second 34b one, of the two H-shaped wedges, is introduced into the same H-shaped channel at an opposite side of the roll 8. Thereafter the tension rod 37 is inserted through the through holes of the wedges 34a, 34b. A tension pressure forcing the two wedges 34a, 34b towards each other is applied at the ends of the tension rod 37 so that the wedging force creating the holding pressure between the segment 22 of the grinding shell 20 and the support structure 11 of the shaft 10 is achieved. The tension pressure is applied using a tension nut 39 at each end of the tension rod 37. The tension nuts 39 are arranged to apply a force pushing each of said two wedges 34a, 34b in a respectively axially extending wedge locking direction. The wedge locking directions of the two wedges 34a, 34b are pointing towards each other.

According to one embodiment of the present invention the tension nuts 39 used are a MT Torquenut™, CY Torquenut™ or MTSX Torquenut™ as supplied by Superbolt® or a tension nut having similar properties.

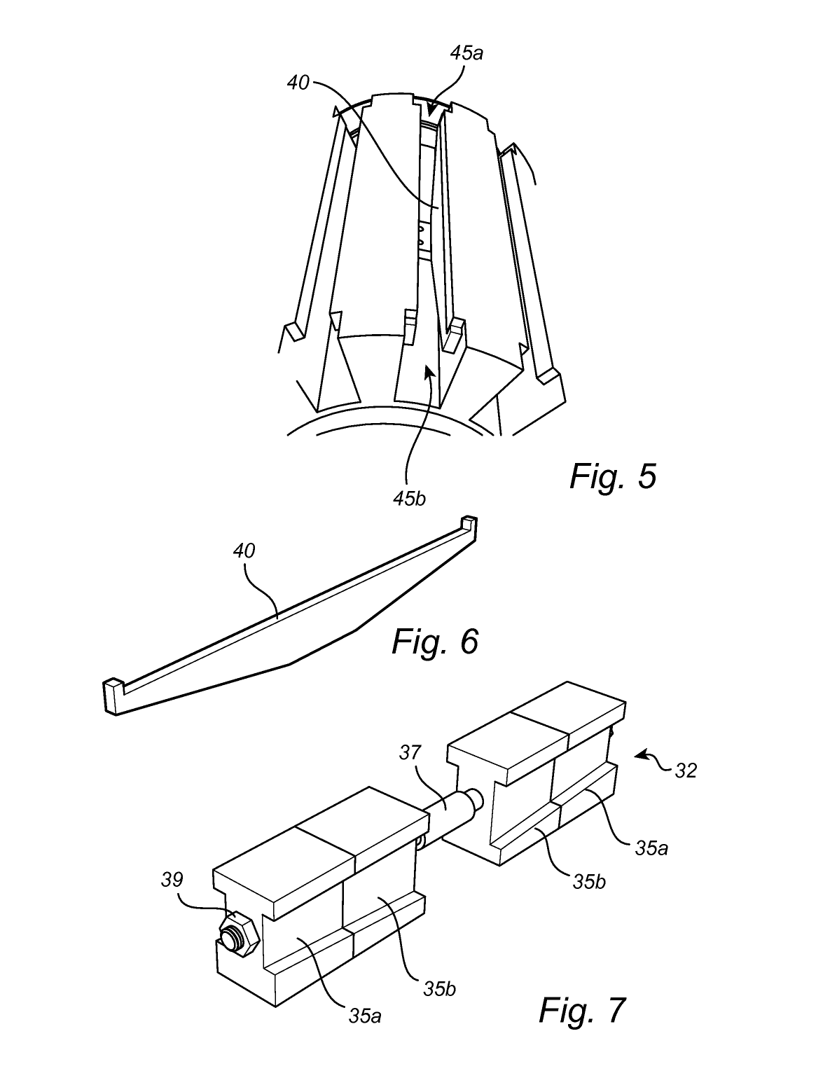

As shown in FIG. 5, the sloped internal surfaces of the support structure grooves 12 (and/or shell grooves 24) can be formed by inserts 40. This is advantageous since grooves with sloped internal surfaces are difficult to manufacture. An additional advantage is that the inserts 40 are replaceable. Such an insert 40 is shown in FIG. 6.

To assure a strong holding pressure between the segments 22 of the grinding shell 20 and the support structure 11 of the shaft 10 the wedges 34a, 34b need to be as long as possible. However, the wedge length is limited by the distance between the edge of the grinding shell 20 and the bearings of the roll 8. To overcome this difficulty the wedges 34a, 34b can be split in two or more wedge portions allowing forming a long contact line between each segment 22 of the grinding shell 20 and the support structure 11 of the shaft 10. A wedging device 32 having wedges being split in two wedge portions 35a, 35b is shown in FIG. 7. The wedge portions 35a, 35b can be introduced by the limited side space between each segment 22 of the grinding shell 20 and the support structure 11 of the shaft 10 but once assembled and locked by the tensioner 37 the wedge portions 35a, 35b will work as one solid piece.

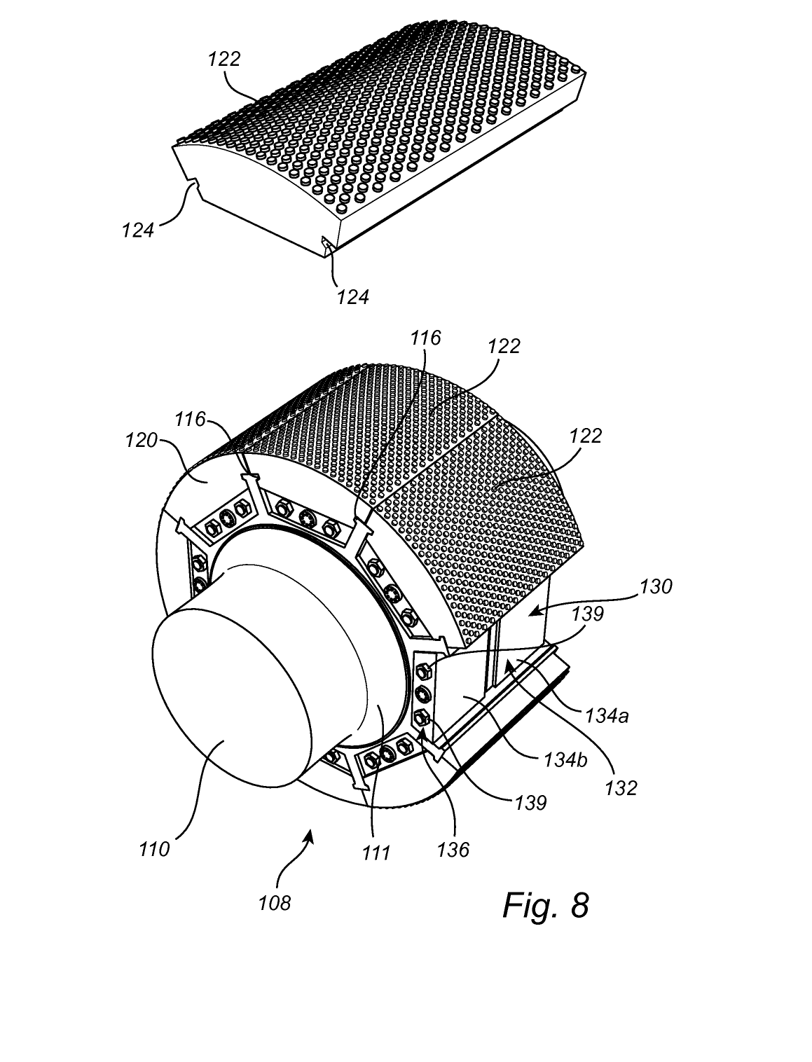

In FIG. 8 an alternative embodiment of a roll 108 of a roller grinder (not fully shown) according to the present invention is shown. The roll 108 comprises a shaft 110, the shaft 110 being held in the roller grinder by two bearings (not shown). Moreover, the roll 108 comprises a grinding shell 120 in the form of a generally tubular sleeve surrounding a support structure 111 of the shaft 110. The grinding shell 120 is divided into a plurality of segments 122. In FIG. 8 one of the segments 122 of the grinding shell 120 is removed in order to more clearly see the function of the present invention. The removed grinding shell segment 122 is also shown in the upper part of the figure.

Each segment 122 is provided with two shell grooves 124 having an extension along the axial direction of the shaft 110. Said shell grooves 124 being arranged at opposite sides of the grinding shell segments 120. The shaft 110 is provided with a plurality of support structure grooves having an extension along the axial direction of the shaft 110. The number of support structure grooves corresponds to the number of segments 122 of the grinding shell 120.

The two shell grooves 124 of the grinding shell segment 120 is arranged to fit in rails 116 provided at the support structure groove.

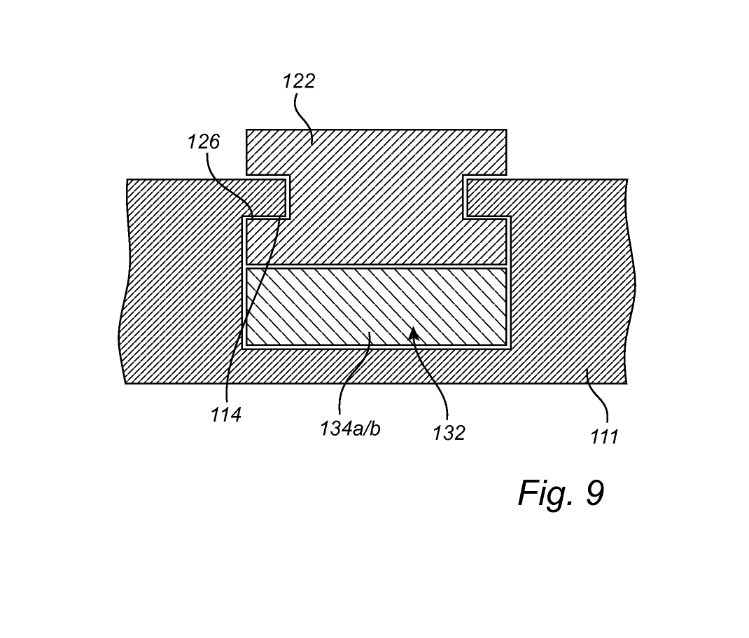

The roll 108 further comprises a plurality of wedging arrangements 130. Each wedging arrangement 130 is arranged to releasably secure one of the grinding shell segments 122 to the support structure 111. This is made by applying a wedging force pressing a segment contact surface 126 of the grinding shell segment 122 and a corresponding support structure contact surface 114 of the support structure 111 against each other. This is illustrated in FIG. 9.

Each wedging arrangement 130 comprises a wedging device 132. The wedging device 132 comprises two wedges 134a, 134b and a tensioner 136. The wedging device 132 is arranged to apply a holding pressure between each segment 122 of the grinding shell 120 and the support structure 111 of the shaft 110. According to this embodiment of the invention the wedging device 132 itself is arranged as a support for the associated grinding shell segment 122.

The wedges 134a, 134b of the wedging device 132 comprise two through holes. Each through hole is arranged to receive a tension rod of the tensioner 136.

In order to achieve the wedging force creating the holding pressure between each segment 122 of the grinding shell 120 and the support structure 111 of the shaft 110 a first 134a one, of the two wedges, is introduced into the channel being formed between the segment 122 and the support structure 111 at a first side of the roll 108 and a second 134b one, of the two wedges, is introduced into the same channel at an opposite side of the roll 108. Thereafter the tension rods are inserted through the through holes of the wedges 134a, 134b. A tension pressure forcing the two wedges 134a, 134b towards each other is applied at the ends of the tension rods so that the wedging force creating the holding pressure between the segment 122 of the grinding shell 120 and the support structure 111 of the shaft 110 is achieved. The tension pressure is applied using a tension nut 139 at each end of the tension rods. The tension nuts 136 are arranged to apply a force pushing each of said two wedges 134a, 134b in a respectively axially extending wedge locking direction. The wedge locking directions of the two wedges 134a, 134b are pointing towards each other.

According to one embodiment of the present invention the tension nuts 139 used are a MT Torquenut™, CY Torquenut™ or MTSX Torquenut™ as supplied by Superbolt® or a tension nut having similar properties.

Also according to the embodiment shown in FIG. 8 the wegdes 134a, 134b of the wedging device 132 may be split in two or more wedge portions.

Above some embodiments of the present invention are described however, it is appreciated that the present invention is not limited to the embodiments shown. Several modifications and variations are thus conceivable within the scope of the invention.

For example, the number of shell grooves 24 on each segment 22 may vary. In the embodiment shown in FIGS. 2-7 each segment 22 comprises two shell grooves 24, however, one shell groove 24 on each segment 22 may also be used as well as any other number of shell grooves 24.

The shape of the shell grooves 24 as well as the support structure grooves may vary and accordingly also the shape of the wedges of the wedging device inserted in the channel defined by said grooves may vary. In the embodiment shown in FIGS. 2-7 the channel as well as the wedges fitting inside the channel are H-shaped. However, any other form of the channel as well as the wedges are possible as long as the channel extending axially along said shaft and defined by the associated grinding shell segment and the support structure is provided with a waist arranged in an interface surface between said grinding shell segment and said support structure and accordingly also the wedges is provided with a corresponding waist. Providing the channel and the wedges with a waist results in that the wedges will be arranged to pull the segment of the grinding shell towards the support of the shaft.

The number of through holes arranged in each wedging device may also vary. In the embodiment of FIGS. 2-7 a single through hole for receiving a single tension rod was used. However, any number of through holes suitable may be used. For example in the embodiment shown in FIG. 8 two rods and two through holes for receiving the rods are used for each wedging device.

The tensioner need not be a tension rod with nuts at the ends. It may, e.g., be a tension bolt with a nut at the side without the bolt head. Any other kind of suitable tensioners known by the skilled person is also possible to use.

The wedging device may comprise more than two wedges.

As seen in FIG. 5, each of said support structure grooves may also comprise a slot 45a, 45b at each end of the support structure groove where the wedges of the wedging device are introduced. By arranging the slots 45a, 45b at the ends of the support structure groove it will be possible to introduce and/or remove a wedge of the wedging device. Moreover, the slots 45a, 45b at the ends of the support structure groove facilitate introduction and removal of wedges having a longer length than if the slots 45a, 45b would be absent.

According to the embodiments disclosed above each grinding shell segment is made up by one part. However it would be possible to split each segment in two or more parts along its length, i.e. along the direction being parallel to the axial direction of the shaft. Smaller pieces of the segments may be an advantage when mounting the segments to the shaft.

1. Roll for a roller grinder, the roll comprising:
a shaft having a support structure;
a plurality of grinding shell segments circumferentially arranged around said shaft to form a tubular grinding shell supported by said support structure; and
a wedging arrangement for each grinding shell segment,
wherein each wedging arrangement comprises at least one wedging device arranged in a channel extending axially along said shaft and defined by the associated grinding shell segment and the support structure,
wherein each wedging arrangement is arranged to releasably secure said grinding shell segment to said support structure.

2. Roll according to claim 1, wherein each wedging arrangement is arranged to apply a wedging force pressing a segment contact surface of the grinding shell segment and a corresponding support structure contact surface of the support structure against each other.

3. Roll according to claim 1, wherein each channel has an axial extension along said shaft being as long as the associated grinding shell segment.

4. Roll according to claim 3, wherein each wedging device is arranged to apply a wedging force along the whole axial extension of the associated grinding shell segment.

5. Roll according to claim 1, wherein said wedging device comprises at least one wedge and a tensioner, wherein said tensioner is arranged to apply a force pushing said at least one wedge in a wedge locking direction extending axially along said shaft.

6. Roll according to claim 5, wherein said wedging device comprises two wedges having opposed wedge locking directions, and wherein said tensioner is arranged to apply a force pushing each of said two wedges in its wedge locking direction, respectively.

7. Roll according to claim 5, wherein said at least one wedge is segmented into a plurality of wedge portions.

8. Roll according to claim 5, wherein said tensioner comprises a rod at least one tension nut.

9. Roll according to claim 1, wherein each grinding shell segment comprises a groove which together with a groove in said support structure of said shaft defines the channel associated thereto.

10. Roll according claim 9, wherein said groove of each grinding shell Segment and said groove in said support structure are both T-shaped in a cross section being perpendicular to the axial extension of said shaft.

11. Roll according claim 1, wherein said channel extending axially along said shaft and defined by the associated grinding shell segment and the support structure is provided with a waist arranged in an interface surface between said grinding shell segment and said support structure.

12. Roll according to claim 5, wherein said at least one wedge is H-shaped in a cross section being perpendicular to the axial extension of said shaft.

13. A high pressure roller grinder comprising a roll according to claim 1.
